(19) United States
(12) Patent Application Publication
(10) Pub. No.: US 2026/0250154 A1
(43) Pub. Date: Aug. 27, 2026

(54) METAL COMPOSITE COMPOUND AND METHOD FOR PRODUCING LITHIUM METAL COMPOSITE OXIDE

(71) Applicant: TANAKA CHEMICAL CORPORATION, Fukui (JP)

(72) Inventor: Tomoya KURODA, Fukui-shi (JP)

(21) Appl. No.: 18/881,976

(22) PCT Filed: Jul. 14, 2023
(86) PCT No.: PCT/JP2023/026154

§ 371 Date: Jan. 7, 2025

(30) Foreign Application Priority Data
Jul. 15, 2022 (JP) 2022-114298

(51) Int. Cl. C01G 53/84; C01G 53/05; C01G 53/42; H01M 4/525

(52) U.S. Cl. CPC C01G 53/84; C01G 53/05; C01G 53/42; H01M 4/525; C01P 2002/52; C01P 2002/54; C01P 2004/32; C01P 2004/61; C01P 2006/11; C01P 2006/40

(57) ABSTRACT

Provided is a metal composite compound containing at least Ni and satisfying Expression (1), 1. 10≤S2/S1≤3.50 . . . (1) [where the S1 is 40/(C50−C10), the S2 is 40/(C90−C50), and the C10, the C50, and the C90 are circularities at which cumulative volumes from a side with a smaller circularity are 10%, 50% and 90%, respectively, in a case where a total cumulative volume in a volume-based circularity distribution curve of the metal composite compound is set to 100%].

### TECHNICAL FIELD

The present invention relates to a metal composite compound and a method for producing a lithium metal composite oxide.

Priority is claimed on Japanese Patent Application No. 2022-114298, filed Jul. 15, 2022, the content of which is incorporated herein by reference.

### BACKGROUND ART

As a method for producing a lithium metal composite oxide used for a positive electrode active material for a lithium secondary battery, for example, there is a method in which a lithium compound and a metal composite compound containing a metal element other than Li are mixed and calcined.

In order to achieve battery characteristics of a lithium secondary battery, such as improvement of cycle characteristics, reduction in resistance, or improvement of output, studies have been conducted to control physical properties, such as a particle shape, of a metal composite compound which is a raw material of a positive electrode active material within appropriate ranges.

For the purpose of packing of a positive electrode active material at a high density during the production of a positive electrode, studies have been conducted to control a shape of particles of the positive electrode active material.

For example, Patent Document 1 discloses an invention in which a circularity of nickel manganese composite hydroxide particles is improved, and a packing density of a positive electrode active material using the particles as a precursor is improved. Specifically, Patent Document 1 discloses nickel manganese composite hydroxide particles having an average circularity of 0.82 or more.

### CITATION LIST

### Patent Document

Patent Document 1: PCT International Publication No. WO2015/115547A1

### SUMMARY OF INVENTION

### Technical Problem

In order to further improve battery performance of the lithium secondary battery, there is room for further study on a shape of particles of the metal composite compound serving as a precursor.

The present invention has been made in view of the above-described circumstances, and an objective of the present invention is to provide a metal composite compound that is a raw material of a positive electrode active material, with which a lithium secondary battery having a high initial charge-discharge efficiency is obtained.

### Solution to Problem

The present invention includes the following aspects.

[1]A metal composite compound containing at least Ni and satisfying Expression (1),

$$1. 10 \leq S 2 / S 1 \leq 3.50 \qquad ( 1 )$$

[where the S1 is 40/(C50−C10), the S2 is 40/(C90−C50), and the C10, the C50, and the C90 are circularities at which cumulative volumes from a side with a smaller circularity are 10%, 50% and 90%, respectively, in a case where a total cumulative volume in a volume-based circularity distribution curve of the metal composite compound is set to 100%].

[2] The metal composite compound according to [1], in which the C10 is 0.75 or less, the C50 is 0.93 or less, and the C90 is 0.95 or more.

[3] The metal composite compound according to [1] or [2], in which the C10, the C50, and the C90 satisfy Expression (2),

$$0.2 \leq ( C 90 - C 10 ) / C 50 \leq 0.50 \qquad ( 2 )$$

[4] The metal composite compound according to any one of [1] to [3], in which the S1 is 200 or more and 300 or less, and the S2 is 340 or more and 1,050 or less.

[5] The metal composite compound according to any one of [1] to [4], in which a tap density of the metal composite compound is less than 2.20 g/cm³.

[6] The metal composite compound according to any one of [1] to [5], in which, in a case where a total cumulative volume in a cumulative particle size distribution curve obtained by measuring the metal composite compound with a laser diffraction type particle size distribution measuring device is set to 100%, a particle diameter D₅₀ at which a cumulative volume from a small particle side is 50% is 3 μm or more and 20 μm or less.

[7] The metal composite compound according to any one of [1] to [6], in which the metal composite compound is represented by Composition Formula (A),

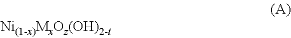

(in Composition Formula (A). 0<x≤0.3, 0≤z≤3, −0.5≤t≤2, and t−z<2 are satisfied, and M is one or more elements selected from the group consisting of Co, Mn, Fe, Cu, Ti, Mg, Al, W, Mo, Nb, Zn, Sn, Zr, Ga, V, B, Si, S, and P).

[8]A method for producing a lithium metal composite oxide, including: a step of mixing the metal composite compound according to any one of [1] to [7] with a lithium compound and calcining an obtained mixture.

### Advantageous Effects of Invention

According to the present invention, it is possible to provide a metal composite compound that is a raw material of a positive electrode active material, with which a lithium secondary battery having a high initial charge-discharge efficiency is obtained.

### BRIEF DESCRIPTION OF DRAWINGS

FIG. 1 A schematic configuration view showing an example of a lithium secondary battery.

FIG. 2 A schematic view showing an entire configuration of an all-solid-state lithium secondary battery.

FIG. 3 An example of a volume-based circularity distribution curve of a metal composite compound.

### DESCRIPTION OF EMBODIMENTS

In the present specification, “high initial charge-discharge efficiency” means that a value of an initial charge-discharge efficiency measured by the following method is 85% or more.

In the present specification, a metal composite compound is hereinafter referred to as “MCC”, and a lithium metal composite oxide is hereinafter referred to as “LiMO”.

A positive electrode active material for a lithium secondary battery (cathode active material for lithium secondary batteries) is hereinafter referred to as “CAM”.

A notation “Ni” does not indicate a simple Ni metal, but a Ni element unless particularly otherwise specified. The same applies to notations of other elements such as Co and Mn.

In a case where a numerical range is described as, for example, “1 to 10 μm”, the numerical range means a range from 1 μm to 10 μm and means a numerical range including 1 μm as a lower limit and 10 μm as an upper limit.

[Calculation of initial Charge-Discharge Efficiency of Lithium Secondary Battery]

An initial charge-discharge efficiency of a lithium secondary battery is calculated by producing a lithium secondary battery by the following method.

### (Production of LiMO)

An MCC and a lithium hydroxide monohydrate powder are weighed and mixed in a molar ratio of Li/(Ni+M)=1.02 to obtain a mixture. The obtained mixture is calcined at 740° C. for five hours in an oxygen-containing atmosphere to obtain a LiMO.

### (Production of Positive Electrode for Lithium Secondary Battery)

A paste-like positive electrode mixture is prepared by adding and kneading a CAM composed of the LiMO that is produced by the above-described method, a conductive material (acetylene black), and a binder (PVdF) in proportions at which a composition of CAM:conductive material:binder=92:5:3 (mass ratio) is achieved. During the preparation of the positive electrode mixture, N-methyl-2-pyrrolidone is used as an organic solvent.

The obtained positive electrode mixture is applied to a 40 μm-thick Al foil serving as a current collector and dried in a vacuum at 150° C. for eight hours to obtain a positive electrode for a lithium secondary battery. An electrode area of the positive electrode for a lithium secondary battery is set to 1.65 cm².

### (Production of Lithium Secondary Battery)

The following operation is performed in a glove box under an argon atmosphere.

The positive electrode for a lithium secondary battery produced in (Production of Positive Electrode for Lithium Secondary Battery) is placed on a lower lid of a part for a coin type battery R2032 (for example, manufactured by Hohsen Corp.) with an aluminum foil surface facing downward, and a separator (a porous layer made of polyethylene) is placed on the positive electrode for a lithium secondary battery. 300 μl of an electrolytic solution is injected thereinto. As the electrolytic solution, a liquid is used in which LiPF₆ is dissolved at a ratio of 1.0 mol/1 in a mixed solution of ethylene carbonate, dimethyl carbonate, and ethyl methyl carbonate mixed in a ratio (volume ratio) of 30:35:35.

Next, metal lithium is used as a negative electrode, and the negative electrode is placed on an upper side of a laminated film separator, covered with an upper lid via a gasket, and caulked by a caulking machine, whereby a lithium secondary battery (coin type half cell R2032) is produced. As the laminated film separator, a laminated film separator having a thickness of 16 μm and having a heat-resistant porous layer laminated on a polyethylene porous film is used.

### (Charge and Discharge Test)

An initial charge-discharge efficiency test is conducted by the following method using the lithium secondary battery produced by the above-described method, and the initial charge-discharge efficiency of the lithium secondary battery is calculated.

### (Measurement Method)

First, the lithium secondary battery produced by the above-described method is left to stand at room temperature for 12 hours to sufficiently impregnate the separator and a positive electrode mixture layer with the electrolytic solution.

Next, at a testing temperature of 25° C., a set current value is set to 0.2 CA for both charging and discharging, and each of constant-current constant-voltage charging and constant-current discharging is performed. A maximum charge voltage is set to 4.3V, and a minimum discharge voltage is set to 2.5V. A charge capacity is measured, and the obtained value is defined as an “initial charge capacity” (mAh/g). A discharge capacity is measured, and the obtained value is defined as an “initial discharge capacity” (mAh/g).

In addition, the initial charge-discharge efficiency is calculated by the following expression using the value of the initial discharge capacity and the value of the initial charge capacity.

$$Initial charge - discharge efficiency ( \% ) = initial discharge capacity ( mAh / g ) / initial charge capacity ( mAh / g ) \times 100$$

### <MCC>

The MCC of the present embodiment contains at least Ni. It is preferable that the MCC contains Ni and an element M. Examples of the element M include one or more elements selected from the group consisting of Co, Mn, Fe, Cu, Ti, Mg, Al, W, Mo, Nb, Zn, Sn, Zr, Ga, V, B, Si, S, and P. In addition, the MCC more preferably contains one or more elements selected from the group consisting of Co, Mn, and Al, and still more preferably contains two or more elements selected from the group consisting of Co, Mn, and Al.

When the MCC and a lithium compound are mixed and calcined, a LiMO can be produced.

The MCC is preferably constituted by primary particles and secondary particles which are aggregates of the primary particles.

The MCC is preferably a powder.

The “primary particles” mean particles having no grain boundary in appearance when observed in a visual field at 5,000 to 30,000 times using a scanning electron microscope or the like.

The “secondary particle” is a particle in which the primary particles are aggregated. That is, the secondary particle is an aggregate of the primary particles.

Examples of the MCC include a metal composite oxide or a metal composite hydroxide containing Ni, and a metal composite oxide or a metal composite hydroxide containing Ni and an element M.

The MCC satisfies Expression (1) described later in a circularity distribution curve obtained by the method described in [Method of Measuring Circularity] described later.

### [Method of Measuring Circularity]

First, an image of the MCC is captured to obtain a particle image which is a projection image of the MCC. Next, a circularity calculated by Expression (X) is measured for each particle constituting the MCC. A circularity distribution curve of the MCC is obtained with the obtained circularity on a horizontal axis and a cumulative volume on a vertical axis.

The circularity shown in Expression (X) means that the closer the numerical value is to 1, the closer the shape is to a perfect circle.

$$Circularity = 4 π S / {L}^{2} \qquad ( X )$$

(S is a projected area of the particle image of the MCC, and L is a peripheral length of the MCC)

For the measurement of the circularity, for example, Morphologi series (device name: Morphologi G3SE) manufactured by Malvern Panalytical Ltd. can be used.

The MCC satisfies Expression (1) in the circularity distribution curve obtained by the above-described method.

$$1. 10 \leq S 2 / S 1 \leq 3.50 \qquad ( 1 )$$

[Si is 40/(C50−C10), S2 is 40/(C90−C50), and C10, C50, and C90 are circularities at which cumulative volumes from a side with a smaller circularity are 10%, 50% and 90%, respectively, in a case where a total cumulative volume in a volume-based circularity distribution curve of the MCC obtained above is set to 100%].

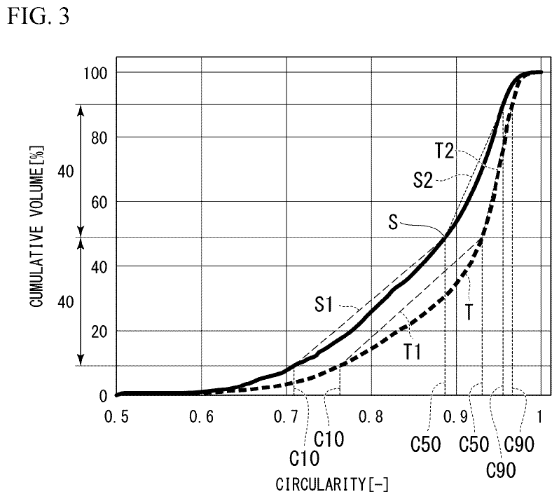

Expression (1) will be described with reference to FIG. 3.

A circularity distribution curve S in FIG. 3 is an example of the volume-based circularity distribution curve of the MCC of the present embodiment.

S1, which is 40/(C50−C10), indicates a slope of a straight line indicated by S1 in FIG. 3.

S1 indicates a rate of increase in the MCC having a low circularity.

S2, which is 40/(C90−C50), indicates a slope of a straight line indicated by S2 in FIG. 3.

S2 indicates a rate of increase in the MCC having a high circularity.

A circularity distribution curve T in FIG. 3 is an example of a volume-based circularity distribution curve of an MCC that is not in the present embodiment.

A slope of a straight line indicated by T1 in FIG. 3 is 40/(C50−C10).

A slope of a straight line indicated by T2 in FIG. 3 is 40/(C90−C50).

A large S2/S1 value indicates that there are many particles having a high circularity, and a low S2/S1 value indicates that there are many particles having a low circularity.

From the viewpoint of obtaining a CAM that can be packed at a high density during the production of a positive electrode, various studies have been conducted under the concept of increasing the circularity of the MCC, which is a raw material of a LiMO used as the CAM.

According to the study by the present inventors, it has been found that in a case where a precursor in which an MCC having a low circularity occupies a certain volume is used, a reaction is likely to proceed when a mixture mixed with a lithium compound is calcined.

It is presumed that this is because, in a case of comparing mixtures having the same volume and the same average particle diameter, a mixture in which an MCC having a low circularity occupies a certain volume has a higher surface area for contact between the lithium compound and the MCC.

In a lithium secondary battery including a CAM obtained using the MCC, which easily reacts with the lithium compound, as a raw material, a contact area between the CAMs inside the battery increases, so that lithium ions are likely to move smoothly, and the initial charge-discharge efficiency is likely to increase.

In a case where S2/S1 is equal to or more than the above-described lower limit, the MCC having a low circularity contributes to an increase in the surface area of the entire MCC, and the contact area with the lithium compound increases, facilitating the reaction.

In a case where S2/S1 is equal to or less than the above-described upper limit, an amount of the MCC having a low circularity is not too large, and a proportion of an MCC having a distorted shape is small. In this case, the MCC and the lithium compound are more likely to be in surface contact than in point contact, so that the surface area for contact increases, facilitating the reaction with the lithium compound.

(1) is preferably Expression (1)-1, more preferably Expression (1)-2, and particularly preferably Expression (1)-3.

$$1. 20 \leq S 2 / S 1 \leq 3 \text{.40} \qquad ( 1 ) - 1$$

$$1. 40 \leq S 2 / S 1 \leq 3.30 \qquad ( 1 ) - 2$$

$$1. 50 \leq S 2 / S 1 \leq 3.20 \qquad ( 1 ) - 3$$

C10 is preferably 0.75 or less, preferably 0.50 or more, and more preferably 0.50 to 0.75.

C50 is preferably 0.93 or less, preferably 0.80 or more, and more preferably 0.80 to 0.93.

C90 is preferably 0.95 or more, preferably 1.00 or less, and more preferably 0.96 to 1.00.

C10, C50, and C90 within the above-described ranges mean that the MCC having a low circularity occupies a certain volume. In a lithium secondary battery including a CAM obtained using such an MCC as a raw material, the CAMs are likely to come into contact with each other inside the battery, so that lithium ions are likely to move smoothly, and the initial charge-discharge efficiency is likely to increase.

C10, C50, and C90 preferably satisfy Expression (2).

$$0.2 \leq ( C 90 - C 10 ) / C 50 \leq 0.50 \qquad ( 2 )$$

(C90−C10)/C50 within the above-described range means that the MCC has a certain variation in circularity and has a small bias toward a specific circularity. In a lithium secondary battery including a CAM obtained using such an MCC as a raw material, the CAMs are likely to come into contact with each other inside the battery, so that lithium ions are likely to move smoothly, and the initial charge-discharge efficiency is likely to increase.

With the MCC satisfying Expressions (1) and (2), the MCC and the lithium compound are more likely to come into contact with each other, so that the reaction with the lithium compound is facilitated. As a result, the initial charge-discharge efficiency of the lithium secondary battery can be further increased.

S1 is preferably 200 or more, more preferably 210 or more, and particularly preferably 220 or more. S1 is preferably 300 or less, more preferably 290 or less, and particularly preferably 280 or less. S1 is preferably 200 to 300, more preferably 210 to 290, and particularly preferably 220 to 280.

S2 is preferably 340 or more, more preferably 360 or more, and particularly preferably 380 or more. S2 is preferably 1,050 or less, more preferably 1,000 or less, and particularly preferably 950 or less. S2 is preferably 340 to 1,050, more preferably 360 to 1,000, and particularly preferably 380 to 950.

In a case where at least one of Si or S2 is within the above-described range, particles having different circularities are present in a preferable proportion even in a region having a low circularity or a region having a high circularity. Therefore, there is no bias in circularity, and it is easy to enhance the reactivity with the lithium raw material in the entire powder, the particle shape in a case of being used for a CAM, and the contact between particles. As a result, the initial charge-discharge efficiency of the lithium secondary battery is likely to increase.

A tap density of the MCC is preferably less than 2.20 g/cm³, more preferably 2.00 g/cm³ or less, particularly preferably less than 2.00 g/cm³, and still more preferably less than 1.74 g/cm³.

The tap density of the MCC is, for example, 1.25 g/cm³ or more or 1.40 g/cm³ or more.

The above-described upper limit and lower limit of the tap density of the MCC can be randomly combined. The tap density of the MCC is preferably 1.25 g/cm³ or more and less than 2.20 g/cm³, more preferably 1.25 to 2.00 g/cm³, particularly preferably 1.40 g/cm³ or more and less than 2.00 g/cm³, and still more preferably 1.40 g/cm³ or more and less than 1.74 g/cm³.

A CAM obtained using the MCC in which the tap density satisfies the above-described range as a raw material is easily packed at a high density in a case of manufacturing a positive electrode, and thus the initial charge-discharge efficiency of the obtained lithium secondary battery is further increased.

### [Method of Measuring Tap Density]

As the tap density, a value obtained by a method described in JIS R 1628-1997 may be used.

D₅₀ of the MCC is preferably 3 μm or more. D₅₀ is preferably 20 μm or less and more preferably 15 μm or less. D₅₀ is preferably 3 to 20 μm and more preferably 3 to 15 μm.

D₅₀ is a particle diameter (μm) at which a cumulative volume from a small particle side is 50% in a case where a total cumulative volume in a cumulative particle size distribution curve obtained by measuring the MCC with a laser diffraction type particle size distribution measuring device is set to 100%.

The MCC in which D₅₀ is in the above-described range is more likely to react more uniformly with the lithium compound. As a result, the initial charge-discharge efficiency of the lithium secondary battery can be increased.

### [Method of Measuring D₅₀]

A “cumulative volume particle size” is a value measured by a laser diffraction scattering method. Specifically, 0.1 g of the MCC is put into 50 ml of a 0.2 mass % sodium hexametaphosphate aqueous solution to obtain a dispersion liquid in which the MCC is dispersed.

Next, a particle size distribution of the obtained dispersion liquid is measured using a laser diffraction type particle size distribution measuring device (for example, Microtrac MT3300EXII manufactured by MicrotracBEL Corp.) to obtain a volume-based cumulative particle size distribution curve. D₅₀ (μm) is obtained from the obtained cumulative particle size distribution curve.

The MCC is preferably represented by Composition Formula (A).

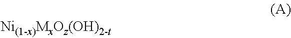

(in Composition Formula (A), 0<x≤0.3, 0≤z≤3, −0.5≤t≤2, and t−z<2 are satisfied, and M is one or more elements selected from the group consisting of Co, Mn, Fe, Cu, Ti, Mg, Al, W, Mo, Nb, Zn, Sn, Zr, Ga, V, B, Si, S, and P).

The MCC is preferably a hydroxide having Composition Formula (A)-1.

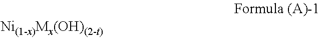

(in Composition Formula (A)-1, 0<x≤0.3 and −0.5≤t<2 are satisfied, and M is one or more elements selected from the group consisting of Co, Mn, Fe, Cu, Ti, Mg, Al, Zn, Sn, Zr, Nb, Ga, W, Mo, V, Si, S, and P)
   (x)

From the viewpoint of increasing the initial charge-discharge efficiency, x is preferably 0.01 or more, more preferably 0.02 or more, and particularly preferably 0.03 or more.

In addition, x is preferably less than 0.3, more preferably 0.25 or less, and particularly preferably 0.20 or less.

The upper limit and lower limit of x can be randomly combined.

Composition Formula (A) or Composition Formula (A)-1 preferably satisfies 0.01≤x≤0.3, more preferably satisfies 0.01≤x<0.3, particularly preferably satisfies 0.02≤x≤0.25, and still more preferably satisfies 0.03≤x≤0.20.

(z)

z is preferably 0.02 or more, more preferably 0.03 or more, and particularly more preferably 0.05 or more.

z is preferably 2.8 or less, more preferably 2.6 or less, and particularly preferably 2.4 or less.

The upper limit and lower limit of z can be randomly combined.

Composition Formula (A) preferably satisfies 0≤z≤2.8, more preferably satisfies 0.02≤z≤2.8, particularly preferably satisfies 0.03≤z≤2.6, and still more preferably satisfies 0.05≤z≤2.4.

(t)

t is preferably −0.45 or more, more preferably −0.40 or more, and still more preferably −0.35 or more.

t is preferably 1.8 or less, more preferably 1.6 or less, and particularly preferably 1.4 or less. The upper limit and lower limit of t can be randomly combined.

Composition Formula (A) or Composition Formula (A)-1 preferably satisfies −0.45≤t23 1.8, more preferably satisfies −0.40≤t≤1.6, and particularly preferably satisfies −0.35≤t23 1.4.

Composition Formula (A) or Composition Formula (A)-1 preferably satisfies 0.01≤x≤0.3, 0≤z≤2.8, and −0.45≤t≤1.8.

In Composition Formula (A) or Composition Formula (A)-1, M is preferably one or more elements selected from the group consisting of Co, Mn, Al, W, B, Nb, and Zr. In addition, M more preferably includes one or more elements selected from the group consisting of Co, Mn, and Al, and more preferably includes two or more elements selected from the group consisting of Co, Mn, and Al.

### [Composition Analysis of MCC]

Composition analysis of the MCC can be measured using an ICP emission spectrometer after dissolving the obtained MCC in hydrochloric acid.

As the ICP emission spectrometer, for example, Optima 8300 manufactured by Perkin Elmer Inc. can be used.

### <Method for Producing MCC>

A method for producing the MCC is a method including a step of continuously supplying a metal-containing aqueous solution and an alkaline aqueous solution to a reaction tank, causing continuous crystal growth, and continuously taking out an MCC.

Specific examples thereof include a method of producing a metal composite hydroxide by reacting a metal-containing aqueous solution with an alkaline aqueous solution by a continuous co-precipitation method described in JP-A-2002-201028.

Examples of the metal-containing aqueous solution include a metal-containing aqueous solution containing Ni, a metal-containing aqueous solution containing Co, a metal-containing aqueous solution containing Mn, a metal-containing aqueous solution containing Al, a metal-containing aqueous solution containing Ni, Co, and Mn, a metal-containing aqueous solution containing Ni, Co, and Al, and a metal-containing aqueous solution containing Ni, Mn, and Al.

The metal-containing aqueous solution containing Ni, Co, and Mn is a mixed aqueous solution of a nickel salt, a cobalt salt, and a manganese salt.

The metal-containing aqueous solution containing Ni, Co, and Al is a mixed aqueous solution of a nickel salt, a cobalt salt, and an aluminum salt.

The metal-containing aqueous solution containing Ni, Mn, and Al is a mixed aqueous solution of a nickel salt, a manganese salt, and an aluminum salt.

The metal-containing aqueous solution and the alkaline aqueous solution may be supplied to the reaction tank from two or more supply ports, respectively. In addition, in a case where the metal-containing aqueous solution is supplied from two or more supply ports, aqueous solutions containing different metal elements may be respectively supplied from the supply ports.

At least one of the metal-containing aqueous solutions supplied to the reaction tank contains Ni, and may contain Ni and a metal element other than Ni. Examples of the metal element other than Ni, which may be contained in the metal-containing aqueous solution, include the element M.

The nickel salt is not particularly limited, and for example, one or more of nickel sulfate, nickel nitrate, nickel chloride, and nickel acetate can be used.

As the cobalt salt, for example, one or more of cobalt sulfate, cobalt nitrate, cobalt chloride, and cobalt acetate can be used.

As the manganese salt, for example, one or more of manganese sulfate, manganese nitrate, manganese chloride, and manganese acetate can be used.

As the aluminum salt, for example, aluminum sulfate can be used.

Each metal salt is used in such a ratio that an atomic ratio of each metal elements corresponding to a composition ratio of Composition Formula (A) is (1-x):x.

A pH of the metal-containing aqueous solution used in the present embodiment is preferably 7.0 or less.

A pH value in the present specification is defined as a value measured when a temperature of the mixed solution is 40° C. A pH of the mixed solution is measured when the temperature of the mixed solution sampled from the reaction tank reaches 40° C.

The alkaline aqueous solution is, for example, a sodium hydroxide aqueous solution or a potassium hydroxide aqueous solution.

As the alkaline aqueous solution, an aqueous solution having a pH of 12.5 or more is preferably used. Examples of the aqueous solution having a pH of 12.5 or more include a sodium hydroxide aqueous solution and a potassium hydroxide aqueous solution, and in the present embodiment, ammonia water (pH 11 to 12) is not included.

In the present embodiment, in a case where a flow rate of the metal-containing aqueous solution (unit: ml/min) is denoted by N1 and a flow rate of the alkaline aqueous solution (unit: ml/min) is denoted by N2, N1/N2 is adjusted to be in a range of 2.20 to 4.5, and the metal-containing aqueous solution and the alkaline aqueous solution are supplied.

In a case where the metal-containing aqueous solution and the alkaline aqueous solution are each supplied from a plurality of supply ports, a total flow rate of the metal-containing aqueous solutions supplied from the plurality of supply ports is denoted by N1, and a total flow rate of the alkaline aqueous solutions supplied from the plurality of supply ports is denoted by N2.

In the present embodiment, the pH in the reaction tank is not adjusted, and the metal-containing aqueous solution and the alkaline aqueous solution are supplied while maintaining N1/N2, which is a fixed flow rate ratio. That is, in order to adjust the pH of the metal-containing aqueous solution in the reaction tank to a predetermined range, the metal-containing aqueous solution and the alkaline aqueous solution are supplied to the reaction tank at a fixed flow rate ratio, instead of preparing the flow rate of the alkaline aqueous solution to be added to the reaction tank. As a result, unevenness of the pH in the reaction tank constantly occurs and a certain degree of variation occurs in the reaction, and therefore an MCC that satisfies Expression (1) and preferably satisfies Expression (2) is obtained.

The unevenness of the pH occurring in the reaction tank refers to a state in which a region with a high pH and a region with a low pH are dispersed in the reaction tank.

By adjusting N1/N2, C10, C50, C90, Si, S2, the tap density, and D₅₀ of the obtained MCC can be adjusted to the above-described ranges.

The pH in the reaction tank is always uneven in a range of approximately 7.0 to 12.5.

It is preferable that a complexing agent is supplied in addition to the metal-containing aqueous solution and the alkaline aqueous solution.

The complexing agent is a compound capable of forming a complex with nickel ions, cobalt ions, aluminum ions, and manganese ions in an aqueous solution.

Examples of the complexing agent include ammonium ion donors (ammonium salts such as ammonium hydroxide, ammonium sulfate, ammonium chloride, ammonium carbonate, and ammonium fluoride), hydrazine, ethylenediaminetetraacetic acid, nitrilotriacetic acid, uracildiacetic acid, and glycine.

An amount of the complexing agent contained in a mixed solution containing the metal-containing aqueous solution and the complexing agent is, for example, such that a molar ratio to the total number of moles of the metal salts is more than 0 and 2.0 or less.

During the reaction, a temperature of the reaction tank is controlled, for example, within a range of 20° C. to 85° C., preferably 30° C. to 75° C.

The materials in the reaction tank are appropriately stirred and mixed together.

As the reaction tank which is used in the continuous co-precipitation method, an overflow type reaction tank can be used to separate formed reaction precipitates.

In addition to the control of the above conditions, various gases such as an inert gas such as nitrogen, argon, and carbon dioxide, an oxidizing gas such as air and oxygen, or a mixed gas thereof may be supplied into the reaction tank.

After the above reaction, the obtained reaction precipitates are washed with water and then dried to obtain a metal composite hydroxide which is an MCC.

In a case where the MCC is a metal composite oxide, the metal composite hydroxide is heated to produce the metal composite oxide. As a heating time, the total time taken from the start of temperature rise to the end of temperature holding after a temperature is reached is preferably set to 1 to 30 hours. A heating temperature is preferably 400° C. to 700° C.

### [Method for Producing Lithium Metal Composite Oxide]

A method for producing a LiMO includes a step of mixing the MCC and a lithium compound and calcining an obtained mixture (calcining step).

As the lithium compound, one or more selected from the group consisting of lithium carbonate, lithium hydroxide, and lithium hydroxide monohydrate can be used.

The lithium compound and the MCC are mixed in consideration of a composition ratio of a final target product to obtain the mixture of the lithium compound and the MCC.

### [Calcining Step]

The obtained mixture is calcined at a calcining temperature of 500° C. to 1,000° C. in, for example, an oxygen-containing atmosphere. The mixture is calcined, whereby LiMO crystals grow.

The calcining temperature in the present specification is a temperature of an atmosphere in a calcining furnace and means a highest temperature of a holding temperatures (highest holding temperature).

In a case where the calcining step includes a plurality of calcining stages, the calcining temperature means a temperature of a stage in which calcining is performed at the highest holding temperature among the stages.

Specifically, the calcining temperature is preferably 550° C. to 980° C. and preferably 600° C. to 960° C.

In addition, a time for holding the calcining temperature may be 0.1 to 20 hours, and is preferably 0.5 to 10 hours.

In addition, it is preferable that the mixture is calcined in an oxygen-containing atmosphere. Specifically, it is preferable to introduce oxygen gas to create an oxygen-containing atmosphere in the calcining furnace.

As the calcining furnace, a tunnel furnace, a roller hearth kiln, a rotary kiln, or the like can be used.

After the calcining step, a calcined product obtained by the calcination is appropriately crushed and sieved to obtain the LiMO.

### <Lithium Secondary Battery>

A positive electrode for a lithium secondary battery, which is suitable in a case where the LiMO is used as a CAM, will be described. Hereinafter, the positive electrode for a lithium secondary battery will be referred to as a positive electrode in some cases.

Furthermore, a lithium secondary battery suitable as a positive electrode application will be described.

An example of the lithium secondary battery that is suitable in a case where the LiMO is used as a CAM includes a positive electrode, a negative electrode, a separator interposed between the positive electrode and the negative electrode, and an electrolytic solution disposed between the positive electrode and the negative electrode.

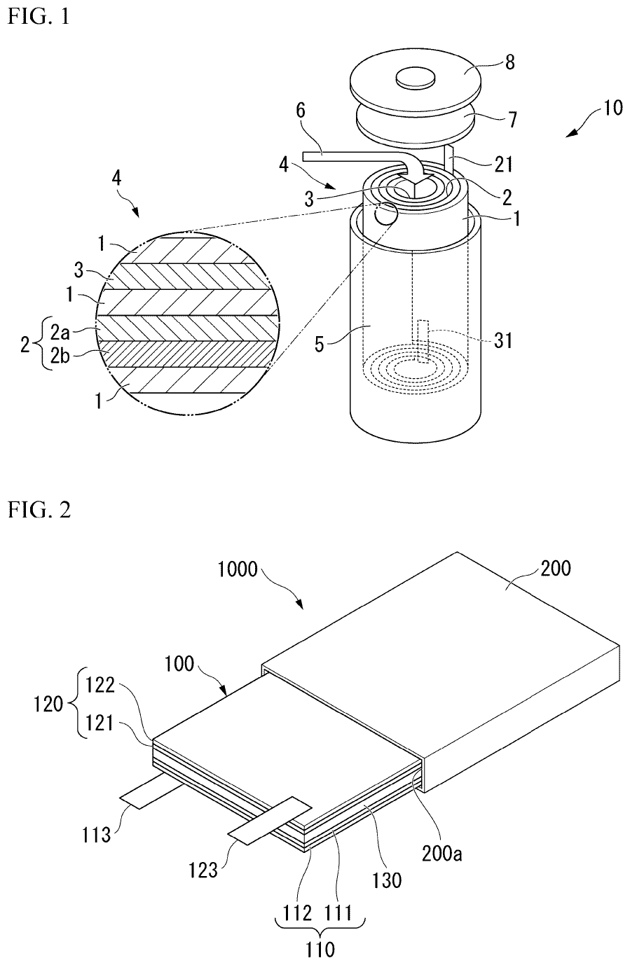

FIG. 1 is a schematic view showing the example of the lithium secondary battery. For example, a cylindrical lithium secondary battery 10 is produced as described below.

First, as shown in a partially enlarged view of FIG. 1, a pair of separators 1 having a strip shape, a strip-shaped positive electrode 2 having a positive electrode lead 21 at one end, and a strip-shaped negative electrode 3 having a negative electrode lead 31 at one end are stacked in order of the separator 1, the positive electrode 2, the separator 1, and the negative electrode 3 and are wound to form an electrode group 4.

The positive electrode 2 includes, for example, a positive electrode active material layer 2a containing the CAM and a positive electrode current collector 2b having the positive electrode active material layer 2a formed on one surface thereof. The positive electrode 2 can be produced by first preparing a positive electrode mixture containing the CAM, a conductive material, and a binder, and supporting the positive electrode mixture on one surface of the positive electrode current collector 2b to form a positive electrode active material layer 2a.

Examples of the negative electrode 3 include an electrode in which a negative electrode mixture containing a negative electrode active material (not shown) is supported on a negative electrode current collector, and an electrode consisting of a negative electrode active material alone, and the negative electrode 3 can be produced in a manner similar to that for the positive electrode 2.

Next, the electrode group 4 and an insulator (not shown) are accommodated in a battery can 5, a can bottom is then sealed, the electrode group 4 is impregnated with an electrolytic solution 6, and an electrolyte is disposed between the positive electrode 2 and the negative electrode 3. Furthermore, an upper portion of the battery can 5 is sealed with a top insulator 7 and a sealing body 8, whereby the lithium secondary battery 10 can be produced.

Examples of a shape of the electrode group 4 include a columnar shape in which a cross-sectional shape when the electrode group 4 is cut in a direction perpendicular to a winding axis becomes a circle, an ellipse, a rectangle, or a rectangle with rounded corners.

In addition, as a shape of the lithium secondary battery having the electrode group 4, a shape defined by IEC60086, which is a standard for a battery defined by the International Electrotechnical Commission (IEC), or by JIS C 8500 can be adopted. Examples thereof include shapes such as a cylindrical shape or a square shape.

Furthermore, the lithium secondary battery is not limited to the wound type configuration, and may have a stacked type configuration in which a stacked structure of a positive electrode, a separator, a negative electrode, and a separator is repeatedly stacked. A so-called coin type battery, a button type battery, and a paper type (or sheet type) battery are exemplary examples of the stacked type lithium secondary battery.

For the positive electrode, the separator, the negative electrode, and the electrolytic solution constituting the lithium secondary battery, for example, the configurations, materials, and production methods described in [0113] to [0140] of WO2022/113904A1 can be used.

### <All-Solid-State Lithium Secondary Battery>

The LiMO can be used as a CAM of an all-solid-state lithium secondary battery.

FIG. 2 is a schematic view showing an example of the all-solid-state lithium secondary battery. An all-solid-state lithium secondary battery 1000 shown in FIG. 2 has a laminate 100 having a positive electrode 110, a negative electrode 120, and a solid electrolyte layer 130 and an exterior body 200 accommodating the laminate 100. In addition, the all-solid-state lithium secondary battery 1000 may have a bipolar structure in which a CAM and a negative electrode active material are disposed on both sides of a current collector. As specific examples of the bipolar structure, for example, the structures described in JP-A-2004-95400 are exemplary examples.

The positive electrode 110 has a positive electrode active material layer 111 and a positive electrode current collector 112. The positive electrode active material layer 111 contains the CAM and a solid electrolyte. In addition, the positive electrode active material layer 111 may contain a conductive material and a binder.

The negative electrode 120 has a negative electrode active material layer 121 and a negative electrode current collector 122. The negative electrode active material layer 121 contains a negative electrode active material. In addition, the negative electrode active material layer 121 may contain a solid electrolyte and a conductive material.

The laminate 100 may have an external terminal 113 that is connected to the positive electrode current collector 112 and an external terminal 123 that is connected to the negative electrode current collector 122. In addition, the all-solid-state lithium secondary battery 1000 may have a separator between the positive electrode 110 and the negative electrode 120.

The all-solid-state lithium secondary battery 1000 further has an insulator (not shown) that insulates the laminate 100 and the exterior body 200 from each other and a sealant (not shown) that seals an opening portion 200a of the exterior body 200.

As the exterior body 200, a container formed of a highly corrosion-resistant metal material such as aluminum, stainless steel, or nickel-plated steel can be used. In addition, as the exterior body 200, a container obtained by processing a laminate film having at least one surface subjected to a corrosion resistant process into a bag shape can also be used.

Example of a shape of the all-solid-state lithium secondary battery 1000 include shapes such as a coin type, a button type, a paper type (or a sheet type), a cylindrical type, a square type, and a laminate type (pouch type).

As an example of the all-solid-state lithium secondary battery 1000, a form in which one laminate 100 is provided is shown in the drawings, but the present embodiment is not limited thereto. The all-solid-state lithium secondary battery 1000 may have a configuration in which the laminate 100 is used as a unit cell and a plurality of unit cells (laminates 100) are sealed inside the exterior body 200.

For the all-solid-state lithium secondary battery, for example, the configurations, materials, and production methods described in [0141] to [0181] of WO2022/113904A1 can be used.

In the lithium secondary battery having the above-described configuration, since the above-described MCC is used as a raw material for the CAM, the initial charge-discharge efficiency of the lithium secondary battery using the CAM can be improved.

The present invention has the following aspects.

[A1] The MCC according to any one of [1] to [8], in which the MCC is a raw material of a positive electrode active material for a lithium secondary battery.

[9] The MCC that contains at least Ni and satisfies Expression (1)-3.

[10] The MCC according to [9], in which the C10 is 0.50 to 0.75, the C50 is 0.80 to 0.93, and the C90 is 0.96 to 1.00.

[11] The MCC according to [9] or [10], in which the C10, the C50, and the C90 satisfy Expression (2).

[12] The MCC according to any one of [9] to [11], in which the S1 is 220 to 280, and the S2 is 380 to 950.

[13] The MCC according to any one of [9] to [12], in which a tap density is 1.40 to 2.20 g/cm³.

[14] The MCC according to any one of [9] to [13], in which D₅₀ of the MCC is 3 to 20 μm.

[15] The MCC according to any one of [9] to [14], in which the MCC is represented by Composition Formula (A)-1.

[16] The MCC according to any one of [9] to [15], in which a tap density is 1.40 g/cm³ or more and less than 1.74 g/cm³.

[17] The MCC according to any one of [9] to [16], in which the MCC contains at least Ni and two or more elements selected from the group consisting of Co, Mn, and Al.

[18] The MCC according to any one of [9] to [17], in which the MCC is a raw material of a positive electrode active material for a lithium secondary battery.

[19]A method for producing a LiMO, including: a step of mixing the MCC according to any one of [9] to [18] with a lithium compound and calcining an obtained mixture.

### EXAMPLES

Next, the present invention will be described in more detail with reference to examples.

### <Compositional Analysis>

The compositional analysis of the MCC was carried out by the method described in [Compositional Analysis of MCC] above.

### <Measurement of Circularity>

The circularity of the MCC was measured as described in [Method of Measuring Circularity] above.

### <Measurement of Tap Density>

The tap density of the MCC was measured as described in [Method of Measuring Tap Density] above.

### <Measurement of D₅₀>

D₅₀ of the MCC was measured as described in [Method of Measuring D₅₀] above.

### <Calculation of Initial Charge-Discharge Efficiency of Lithium Secondary Battery>

The initial charge-discharge efficiency of the lithium secondary battery was acquired by the method described in [Calculation of Initial Charge-Discharge Efficiency of Lithium Secondary Battery].

### Example 1

First, water was put into a reaction tank equipped with a stirrer and an overflow pipe, a sodium hydroxide aqueous solution was supplied thereto, and a liquid temperature (the temperature of the reaction tank) was maintained at 70° C.

A nickel sulfate aqueous solution, a cobalt sulfate aqueous solution, and an aluminum sulfate aqueous solution were mixed to prepare a metal-containing aqueous solution.

Next, the metal-containing aqueous solution and an ammonium sulfate aqueous solution as a complexing agent were each continuously added to the reaction tank at constant flow rates under stirring at a ratio such that an atomic ratio of Ni, Co, and Al in the reaction tank was 88.0:9.0:3.0. In this case, the ratio (N1/N2) of the flow rate (N1) of the metal-containing aqueous solution to the flow rate (N2) of the sodium hydroxide aqueous solution was 2.38. As a result, reaction precipitates were obtained.

After washing the reaction precipitates, the reaction precipitates were dewatered by a centrifuge, isolated, and dried at 105° C. to obtain a nickel cobalt aluminum metal composite hydroxide 1.

### Example 2

First, water was put into a reaction tank equipped with a stirrer and an overflow pipe, a sodium hydroxide aqueous solution was supplied thereto, and a liquid temperature (the temperature of the reaction tank) was maintained at 70° C.

A nickel sulfate aqueous solution, a cobalt sulfate aqueous solution, and a manganese sulfate aqueous solution were mixed to prepare a metal-containing aqueous solution.

Next, the metal-containing aqueous solution and an ammonium sulfate aqueous solution as a complexing agent were each continuously added to the reaction tank at constant flow rates under stirring at a ratio such that an atomic ratio of Ni, Co, and Mn in the reaction tank was 83:12:5. In this case, the ratio (N1/N2) of the flow rate (N1) of the metal-containing aqueous solution to the flow rate (N2) of the sodium hydroxide aqueous solution was 2.98. As a result, reaction precipitates were obtained.

After washing the reaction precipitates, the reaction precipitates were dewatered by a centrifuge, isolated, and dried at 105° C. to obtain a nickel cobalt manganese metal composite hydroxide 1.

### Example 3

First, water was put into a reaction tank equipped with a stirrer and an overflow pipe, a sodium hydroxide aqueous solution was supplied thereto, and a liquid temperature (the temperature of the reaction tank) was maintained at 70° C.

A nickel sulfate aqueous solution, a manganese sulfate aqueous solution, and an aluminum sulfate aqueous solution were mixed to prepare a metal-containing aqueous solution.

Next, the metal-containing aqueous solution and an ammonium sulfate aqueous solution as a complexing agent were each continuously added to the reaction tank at constant flow rates under stirring at a ratio such that an atomic ratio of Ni, Mn, and Al in the reaction tank was 93.0:3.5:3.5. In this case, the ratio (N1/N2) of the flow rate (N1) of the metal-containing aqueous solution to the flow rate (N2) of the sodium hydroxide aqueous solution was 2.33. As a result, reaction precipitates were obtained.

After washing the reaction precipitates, the reaction precipitates were dewatered by a centrifuge, isolated, and dried at 105° C. to obtain a nickel manganese aluminum metal composite hydroxide 1.

### Comparative Example 1

A nickel cobalt aluminum metal composite hydroxide 2 was obtained by the same method as in Example 1, except that N1/N2 was changed to 2.17.

### Comparative Example 2

A nickel cobalt aluminum metal composite hydroxide 3 was obtained by the same method as in Example 1, except that N1/N2 was changed to 4.81.

Table 1 shows C10, C50, C90, (C90−C10)/C50, Si, S2, S2/S1, tap density, and D₅₀ of the metal composite hydroxides obtained in Examples 1 to 3 and Comparative Examples 1 and 2, and the initial charge-discharge efficiency of the lithium secondary battery.

TABLE 1

| | | | | | | | | | | | | | | LIMO |
|---|---|---|---|---|---|---|---|---|---|---|---|---|---|---|
| | | | | | | | | | | | | | | initial |
| | | | | | | TAP | | | | | | | (C90 − | charge- |
| | 1 − x | x | | | D₅₀ | density | | | | | | | C10)/ | discharge |
| | (Ni) | (M) | M | N1/N2 | (μm) | (g/cm³) | C10 | C50 | C90 | S1 | S2 | S2/S1 | C50 | efficiency |
| Example 1 | 0.88 | 0.12 | Co, Al | 2.38 | 12.4 | 1.72 | 0.72 | 0.89 | 0.99 | 235.3 | 400.0 | 1.70 | 0.303 | 88.9 |
| Example 2 | 0.83 | 0.17 | Co, Mn | 2.98 | 12.6 | 2.10 | 0.74 | 0.92 | 0.98 | 222.2 | 666.7 | 3.00 | 0.261 | 86.4 |
| Example 3 | 0.93 | 0.07 | Mn, Al | 2.33 | 13.5 | 1.62 | 0.74 | 0.91 | 0.98 | 236.7 | 634.9 | 2.68 | 0.254 | 88.0 |
| Comparative | 0.88 | 0.12 | Co, Al | 2.17 | 12.0 | 1.74 | 0.77 | 0.93 | 0.97 | 250.0 | 1000.0 | 4.00 | 0.215 | 82.6 |
| Example 1 | | | | | | | | | | | | | | |
| Comparative | 0.88 | 0.12 | Co, Al | 4.81 | 9.0 | 1.21 | 0.69 | 0.81 | 0.94 | 333.3 | 307.7 | 0.92 | 0.309 | 80.5 |
| Example 2 | | | | | | | | | | | | | | |

As shown in the results shown in Table 1, in all the lithium secondary batteries using the CAM produced using the MCC of the present embodiment as a raw material, the initial charge-discharge efficiency was 85% or more.

In Comparative Example 1 in which S2/S1 was more than 3.50 and Comparative Example 2 in which S2/S1 was less than 1.10, the values of the initial charge-discharge efficiency were lower than those in Examples 1 to 3.

It is presumed that in Comparative Example 1, there was an excessive amount of the MCC having a low circularity and thus the proportion of MCC having a distorted shape was high. As a result, it is considered that the MCC and the lithium compound are likely to be in point contact with each other, so that the surface area for contact is small, and it was difficult for the MCC to react with the lithium compound.

It is considered that in Comparative Example 2, there was a small amount of the MCC having a low circularity, so that the contact surface with the lithium compound was small, and it was difficult for the MCC to react with the lithium compound.

### REFERENCE SIGNS LIST

1 Separator
2 Positive electrode
2a Positive electrode active material layer
2b Positive electrode current collector
3 Negative electrode
4 Electrode group
5 Battery can
6 Electrolytic solution
7 Top insulator
8 Sealing body
10 Lithium secondary battery
21 Positive electrode lead
31 Negative electrode lead
100 Laminate
110 Positive electrode
111 Positive electrode active material layer
112 Positive electrode current collector
113 External terminal
120 Negative electrode
121 Negative electrode active material layer
122 Negative electrode current collector
123 External terminal
130 Solid electrolyte layer
200 Exterior body
200a Opening portion
1000 All-solid-state lithium secondary battery

1. A metal composite compound containing at least Ni and satisfying Expression (1),
$$1. 10 \leq S 2 / S 1 \leq 3 \text{.50} \qquad ( 1 )$$
[where the S1 is 40/(C50−C10), the S2 is 40/(C90−C50), and the C10, the C50, and the C90 are circularities at which cumulative volumes from a side with a smaller circularity are 10%, 50% and 90%, respectively, in a case where a total cumulative volume in a volume-based circularity distribution curve of the metal composite compound is set to 100%].

2. The metal composite compound according to claim 1,
wherein the C10 is 0.75 or less, the C50 is 0.93 or less, and the C90 is 0.95 or more.

3. The metal composite compound according to claim 1,
wherein the C10, the C50, and the C90 satisfy Expression (2),
$$0.2 \leq ( C 90 - C 10 ) / C 50 \leq 0.50 \qquad ( 2 )$$

4. The metal composite compound according to claim 1,
wherein the S1 is 200 or more and 300 or less, and the S2 is 340 or more and 1,050 or less.

5. The metal composite compound according to claim 1,
wherein a tap density of the metal composite compound is less than 2.20 g/cm³.

6. The metal composite compound according to claim 1,
wherein, in a case where a total cumulative volume in a cumulative particle size distribution curve obtained by measuring the metal composite compound with a laser diffraction type particle size distribution measuring device is set to 100%, a particle diameter D₅₀ at which a cumulative volume from a small particle side is 50% is 3 μm or more and 20 μm or less.

7. The metal composite compound according to claim 1,
wherein the metal composite compound is represented by Composition Formula (A), 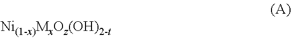
(in Composition Formula (A), 0<x≤0.3, 0≤z≤3, −0.5≤t≤2, and t−z<2 are satisfied, and M is one or more elements selected from the group consisting of Co, Mn, Fe, Cu, Ti, Mg, Al, W, Mo, Nb, Zn, Sn, Zr, Ga, V, B, Si, S, and P).

8. A method for producing a lithium metal composite oxide, comprising:
a step of mixing the metal composite compound according to claim 1 with a lithium compound and calcining the obtained mixture.
